(19) United States
(12) Patent Application Publication
(10) Pub. No.: US 2011/0310967 A1
(43) Pub. Date: Dec. 22, 2011

(54) Method and System for Video and Image Coding Using Pattern Matching for Intra-Prediction

(76) Inventor: Lei Zhang, San Jose, CA (US)

(21) Appl. No.: 13/070,007

(22) Filed: Mar. 23, 2011

Related U.S. Application Data
(60) Provisional application No. 61/357,352, filed on Jun. 22, 2010.

(51) Int. Cl. H04N 7/26

(52) U.S. Cl. 375/240.12; 375/E07.243

(57) ABSTRACT

A method and system are provided in which a device can determine, for a current block of pixels, a first intra-prediction based on reconstructed neighboring pixels and a second intra-prediction based on a pattern match with a reconstructed block of pixels. One of the two intra-predictions may be selected to generate a compressed bit stream comprising information of the current block of pixels. The intra-prediction selection may be performed on a block-by-block basis. An indication may be generated as to which of the two intra-predictions was selected for a particular block of pixels. When pattern matching is selected, a positional relationship of the reconstructed block of pixels with the matching pattern may be encoded and embedded into the compressed bit stream. The same device or another device may be operable to receive a compressed bit stream comprising intra-prediction selection and/or positional relationship information to reconstruct a current block of pixels.

### CROSS-REFERENCE TO RELATED APPLICATIONS/INCORPORATION BY REFERENCE

This application claims priority to and makes reference to U.S. Provisional Patent Application Ser. No. 61/357,352 filed on Jun. 22, 2010.

The above stated application is hereby incorporated herein by reference in its entirety.

### FIELD OF THE INVENTION

Certain embodiments of the invention relate to video and image processing. More specifically, certain embodiments of the invention relate to a method and system for video and image coding using pattern matching for intra-prediction.

### BACKGROUND OF THE INVENTION

Video compression systems, such as those based on H.264, also known as Advanced Video Coding (AVC), for example, utilize temporal redundant information to perform inter-prediction coding and/or spatial redundant information to perform intra-prediction coding of video images. For the compression of still images, intra-prediction coding is typically used. Improvements in intra-prediction coding would produce more efficient video and image compression systems.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for video and image coding using pattern matching for intra-prediction, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a diagram that illustrates an exemplary device that is operable to generate a compressed bit stream using pattern matching for intra-prediction, in accordance with an embodiment of the invention.

FIG. 2 is a diagram that illustrates an exemplary device that is operable to receive and process a compressed bit stream generated using pattern matching for intra-prediction, in accordance with an embodiment of the invention.

FIG. 3A is a diagram that illustrates intra-prediction of a current block of pixels based on prediction direction, in accordance with an embodiment of the invention.

FIG. 3B is a diagram that illustrates intra-prediction of a current block of pixels based on pattern matching, in accordance with an embodiment of the invention.

FIG. 3C is a diagram that illustrates intra-prediction of a current block of pixels based on sub-block pattern matching, in accordance with an embodiment of the invention.

FIGS. 4A and 4B illustrate a flow chart with exemplary steps for the generation of a compressed bit stream when intra-prediction based on pattern match is enabled in a device, in accordance with an embodiment of the invention.

FIG. 5 is a flow chart that illustrates exemplary steps in a block-by-block intra-prediction selection to generate a compressed bit stream, in accordance with an embodiment of the invention.

FIG. 6 is a flow chart that illustrates exemplary steps in the reconstruction of a current block of pixels based on information received in a compressed bit stream for the current block of pixels, in accordance with an embodiment of the invention.

### DETAILED DESCRIPTION OF THE INVENTION

Certain embodiments of the invention can be found in a method and system for video and image coding using pattern matching for intra-prediction. Various embodiments of the invention provide for a device such as an image processing device, which is operable to process video and still images. The device is operable determine, for a current block of pixels, a first intra-prediction based on reconstructed neighboring pixels and a second intra-prediction based on a pattern match with a reconstructed block of pixels. One of the two intra-predictions may be selected to generate a compressed bit stream comprising information related to the current block of pixels. The intra-prediction selection may be performed on a block-by-block basis. An indication may be generated as to which of the two intra-predictions was selected for a particular block of pixels. When intra-prediction based on pattern matching is selected, a positional relationship between the current block of pixels and the reconstructed block of pixels with the matching pattern may be encoded and embedded into the compressed bit stream.

Various embodiments of the invention provide a device that is operable to process video and still images. The device may be operable to receive a compressed bit stream comprising intra-prediction selection information and/or positional relationship information for a current block of pixels. For example, the device may receive an indication that an intra-prediction of the current block of pixels is based on a match between a pattern in the current block of pixels and a pattern in a reconstructed block of pixels. The device may also receive information comprising a positional relationship between the current block of pixels and the reconstructed block of pixels. With the information received, the device may generate the intra-prediction of the current block of pixels and may reconstruct the current block of pixels based on the intra-prediction that is generated.

The methods and/or systems described herein may provide efficient intra-prediction coding for typical video and still images and also for video and still images that have repetitive patterns. Synthetic content, such as synthetic graphics and/or computer images, for example, tend to show repetitive patterns in at least a portion of a video or still image. With the expansion of wired and/or wireless video transport networks, the amount of synthetic content that is being transmitted along with typical content is increasing. Therefore, efficient handling of the increased transmission of different types of video and still image content may be achieved by using the methods and/or systems described herein.

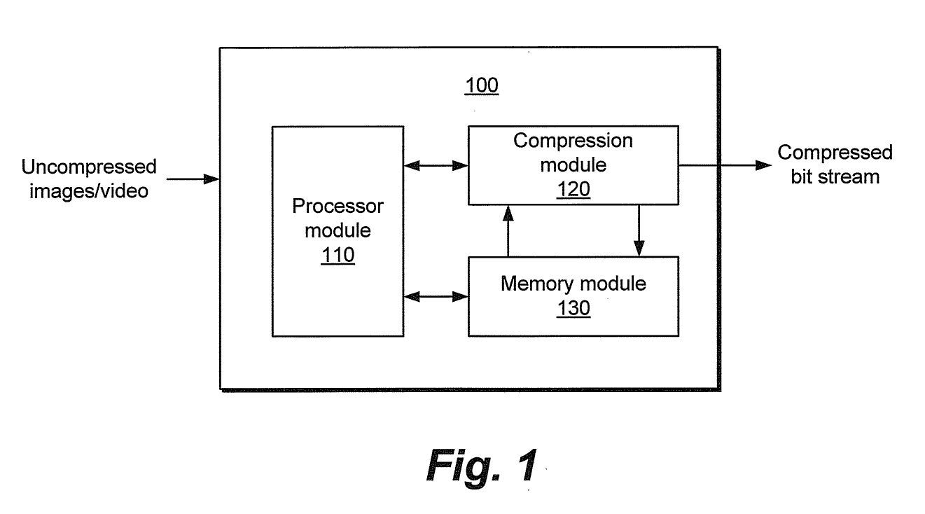

FIG. 1 is a diagram that illustrates an exemplary device that is operable to generate a compressed bit stream using pattern matching for intra-prediction, in accordance with an embodiment of the invention. Referring to FIG. 1, there is shown a device 100 that may comprise a processor module 110, a compression module 120, and a memory module 130. The device 100 may be utilized to process video images or pictures, such as frames or fields, and/or still images. The images may be captured by the device 100 or may be captured by another device and communicated to the device 100 for processing. For example, uncompressed video and/or still images may be communicated to the device 100 from an external device and/or through a network. Some or all of the components or modules of the device 100 may be comprised within a single integrated circuit and/or may be integrated on a single substrate.

The processor module 110 may comprise suitable logic, circuitry, code, and/or interfaces that may be operable to control at least some of the functions, operations, and/or modes of the compression module 120 and/or of the memory module 130. For example, the processor module 110 may control inter-prediction, intra-prediction, transform, quantization, and/or encoding operations performed by the compression module 120. The processor module 110 may also control decoding data path, including inverse quantization, and/or inverse transform operations that may be performed by the compression module 120 to generate reconstructed pixels.

The processor module 110 may be operable to enable and/or disable one or more functions, operations, and/or modes of the compression module 120. For example, the processor module 110 may enable or disable the use of a particular intra-prediction mode from among various different such modes supported by the compression module 120. The processor module 110 may base decisions, regarding which functions, operations, and/or modes to enable or disable, on the type of content being processed by the compression module 120.

The processor module 110 may be operable to control the update, storage, and/or retrieval of information from the memory module 130, and/or the manner in which such update, storage, and/or retrieval takes place. The processor module 110 may store and/or obtain information from the memory module 130 and/or may control the manner in which information is stored and/or obtained from the memory module 130 by another component and/or device.

The memory module 130 may comprise suitable logic, circuitry, and/or code that may be operable to store information that may be utilized by the compression module 130. The memory module 130 may store operating parameters such as prediction, transform, quantization, and/or coding parameters, pixel information such as luminance and chrominance values, and/or intermediate values such as the transform coefficients generated during image compression operations, for example. The memory module 130 may comprise multiple memory devices (not shown) or may be a single memory device.

The compression module 120 may comprise suitable logic, circuitry, code, and/or interfaces that are operable to compress video and/or still images. The compression module 120 may support one or more video compression technologies such as H.264 or AVC, for example. In this regard, the compression module 120 may perform inter-prediction, intra-prediction, transform, quantization, and/or encoding operations on video and still images to produce a compressed bit stream.

The compression module 120 may also be operable to reconstruct blocks of pixels from encoded video and/or still images. Those reconstructed blocks of pixels may be utilized in the compression of other blocks of pixels. Reconstruction operations may comprise inverse quantization and inverse transform operations.

The various operations described herein for the compression module 120 may be carried out on blocks of pixels generally referred to as macro-blocks, which are typically 16×16 pixels in size. However, various aspects associated with the processing of video and still images by the compression module 120 may be performed on smaller block sizes, including 16×8, 8×16, 8×8, 8×4, 4×8, and 4×4, for example.

The inter-prediction operations supported by the compression module 120 may utilize the temporal redundancy that may exist between video images. On the other hand, the intra-prediction operations supported by the compression module 120 may utilize the spatial redundancy that may exist within a video or still image. In a first type of intra-prediction, a current block of pixels in video or still image may be predicted based on encoded and reconstructed pixels of the neighboring block. This type of intra-prediction may be referred to as directional prediction, used by conventional video compression methods such as H.264, also known as AVC, and image compression methods such as lossless Joint Photographic Experts Group (JPEG), also known as JPEG-LS. In another type of intra-prediction, a current block of pixels in a video or still image may be predicted based on matching a pattern in the current block of pixels with a pattern in an encoded and reconstructed block of pixels. This type of intra-prediction may be referred to as pattern match prediction or simply pattern matching. Pattern matching may also be based on matching patterns from various sub-partitions or sub-blocks from one or more reconstructed blocks of pixels to patterns in various sub-partitions or sub-blocks in the current block of pixels.

The compression module 120 may support multiple intra-prediction modes. In a first intra-prediction mode, the compression module 120 may simply perform a conventional intra-prediction, that is, directional prediction. In a second intra- prediction mode, the compression module 120 may perform directional prediction and pattern matching in the blocks of pixels of a video or still image. In this mode, the compression module 120 may select between directional prediction and pattern matching for the intra-prediction of a particular block of pixels based on cost metrics associated with each intra-prediction type. In some embodiments of the invention, the cost metric calculations performed by the compression module 120 are substantially similar for directional prediction and pattern matching. The selection between directional prediction and pattern matching may be performed on a block-by-block basis. Moreover, the block size may be a variable size and may be dynamically adjusted by the compression module 120.

In operation, the processor module 110 may enable the compression module 120 to operate in the second intra-prediction mode described above. While the compression module 120 may be configured to operate in either of the intra-predictions modes described above, it would typically operate in the second intra-prediction mode to support both directional prediction and pattern matching. When the compression module 120 is enabled to operate in the second intra-prediction mode, for each block of pixels that is processed and included in the compressed bit stream, the compression module 120 may generate an indication of whether the intra-prediction type selected for that block of pixels is based on directional prediction or on pattern matching. The indication, which may comprise one or more bits in a signal and/or in an image header to identify the type of intra-prediction selected, is embedded into the compressed bit stream.

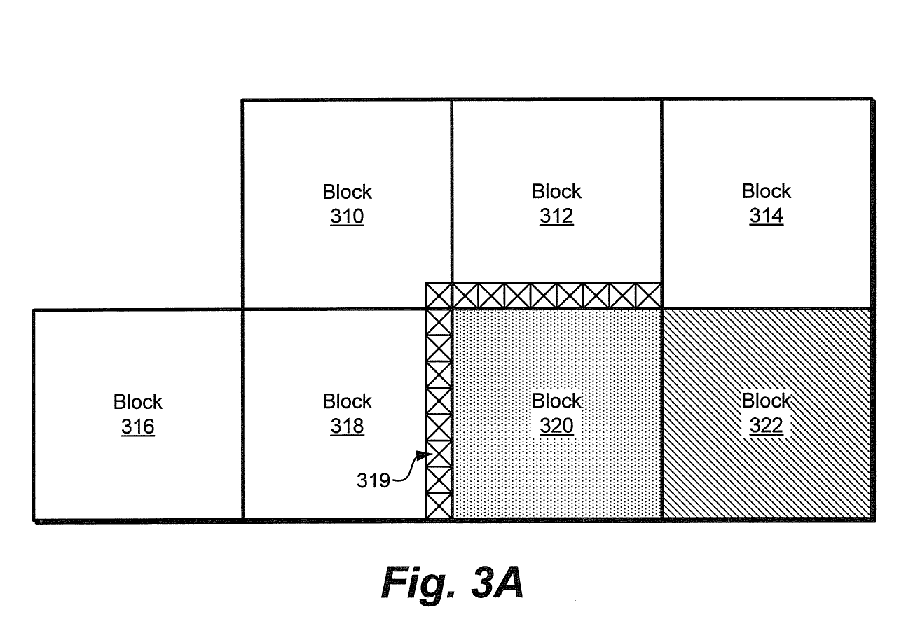

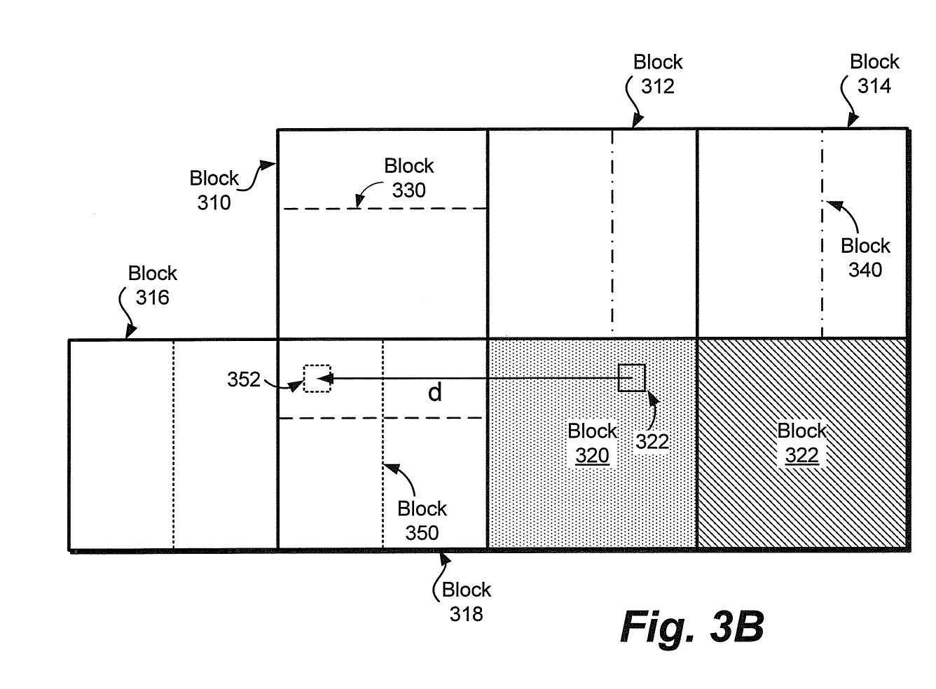

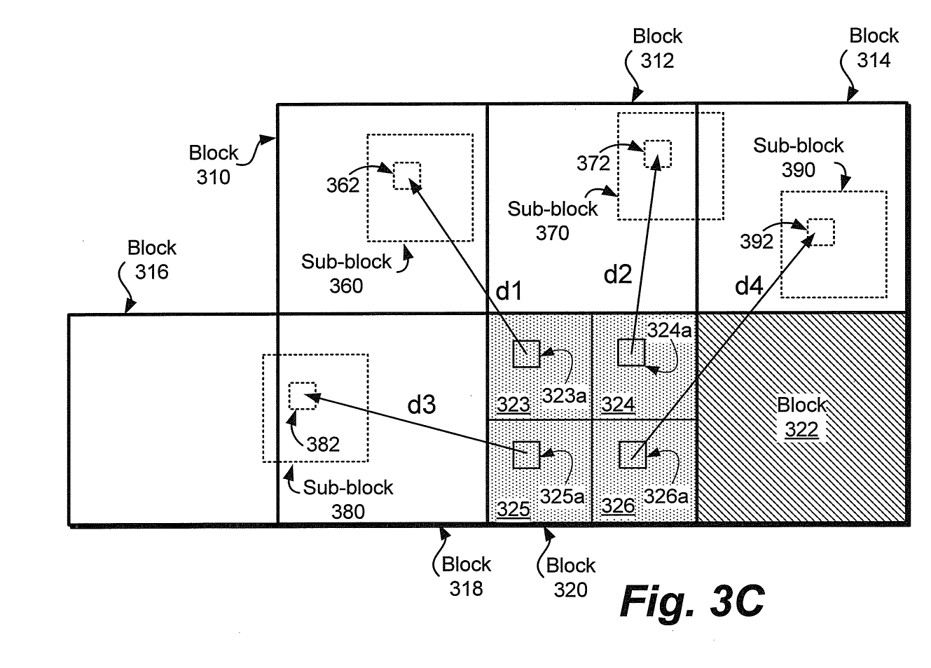

When prediction direction is the intra-prediction type that is selected, the compression module 120 may embed information into the compressed bit stream that indicates the particular prediction mode for the prediction direction. Various prediction modes associated with prediction direction are described below with respect to FIG. 3A.

When pattern matching is the intra-prediction type that is selected, the compression module 120 may also embed information into the compressed bit stream that indicates the positional relationship between the current block of pixels and the reconstructed block of pixels with the matching pattern. This positional relationship may be represented by a two-dimensional vector that provides the position or location of the reconstructed block of pixels in the image relative to the position or location of the current block of pixels in the same image. In those instances, when sub-partitions or sub-blocks in reconstructed blocks of pixels are matched to sub-partitions or sub-blocks in the current block of pixels, the compression module 120 may generate and embed more than one two-dimensional vector or other like parameter to provide information about the positional relationship between corresponding sub-partitions or sub-blocks.

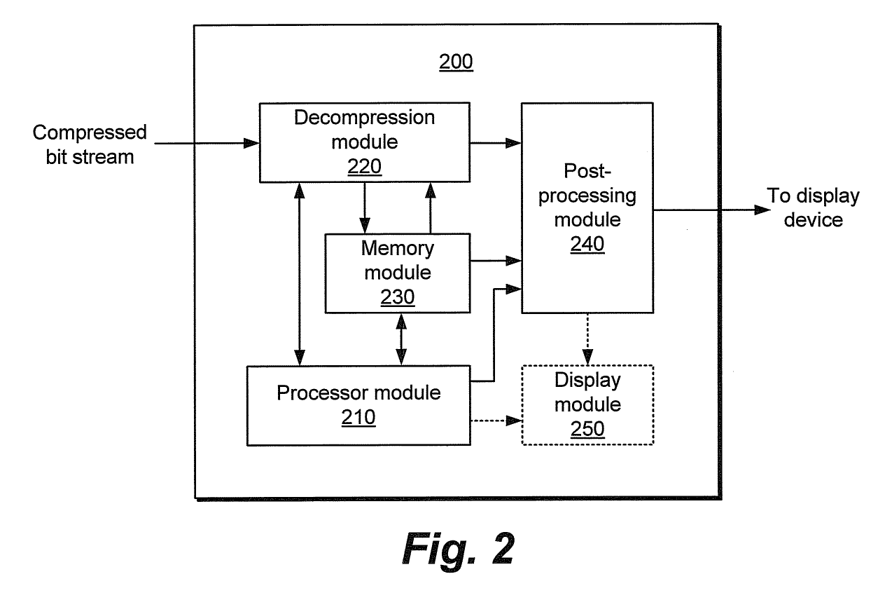

FIG. 2 is a diagram that illustrates an exemplary device that is operable to receive and process a compressed bit stream generated using pattern matching for intra-prediction, in accordance with an embodiment of the invention. Referring to FIG. 2, there is shown a device 200 that may comprise a processor module 210, a decompression module 220, a memory module 230, a post-processing module 240. The device 200 may be utilized to process a compressed bit stream that comprises information related to video and/or still images. In some embodiments of the invention, the device 200 may also comprise a display module 250. Some or all of the components or modules of the device 200 may be comprised within a single integrated circuit and/or may be integrated on a single substrate.

The processor module 210 may comprise suitable logic, circuitry, code, and/or interfaces that may be operable to control at least some of the functions, operations, and/or modes of the decompression module 220, the memory module 230, the post-processing module 240, and/or of the display module 250. For example, the processor module 210 may control decoding, inverse quantization, inverse transform, inter-prediction, and/or intra-prediction operations that may be performed by the decompression module 220.

The processor module 210 may be operable to control the update, storage, and/or retrieval of information from the memory module 230, and/or the manner in which such update, storage, and/or retrieval takes place. The processor module 210 may store and/or obtain information from the memory module 230 and/or may control the manner in which information is stored and/or obtained from the memory module 230 by another component and/or device.

The memory module 230 may comprise suitable logic, circuitry, and/or code that may be operable to store information that may be utilized by the decompression module 230 and/or the post-processing module 240. The memory module 230 may store operating parameters such as prediction, inverse transform, inverse quantization, and/or decoding parameters, pixel information such as luminance and chrominance values, and/or intermediate values such as those generated during image decompression operations, for example. The memory module 230 may comprise multiple memory devices (not shown) or may be a single memory device.

The post-processing module 240 may comprise suitable logic, circuitry, code, and/or interfaces that may be operable to process video and/or still images for display. For example, the post-processing module 240 may receive decoded image information from the decompression module 220 and may arrange, configure, and/or otherwise process the image information for display by a particular display device and/or for display in a particular display format. When the device 200 comprises the display module 250, the post-processing module 240 may be utilized to provide image information to the display module 250 and/or to a device external to the device 200.

The display module 250 may comprise suitable logic, circuitry, code, and/or interfaces that may be operable to visually present the processed image information provided by the post-processing module 240. In some embodiments of the invention, the display module 250 may comprise a display device such as a liquid crystal display (LCD), a flat panel display, a thin-film transistor (TFT) display, a light-emitting diode (LED) or organic LED (OLED) display, a plasma display panel (PDP), or other like device.

The decompression module 220 may comprise suitable logic, circuitry, code, and/or interfaces that may be operable to decompress a compressed bit stream comprising video and/or still image information. The decompression module 220 may support one or more video compression technologies such as H.264 or AVC, for example. The compression module 220 may be operable to reconstruct blocks of pixels from encoded video and/or still images comprised within the compressed bit stream received by the device 200. Reconstruction operations may comprise decoding, inverse quantization, inverse transform, inter-prediction, and/or intra-prediction operations.

The various operations described herein for the decompression module 200 may be carried out on blocks of pixels generally referred to as macro-blocks, which are typically 16×16 pixels in size. However, various aspects associated with the processing of the compressed bit stream by the decompression module 200 may be performed on smaller block sizes, including 16×8, 8×16, 8×8, 8×4, 4×8, and 4×4, for example.

The decompression module 220 may support directional prediction and pattern matching for intra-prediction operations. The decompression module 220 may also support pattern matching based on matching patterns from various sub-partitions or sub-blocks in reconstructed blocks of pixels to patterns in various sub-partitions or sub-blocks of a current block of pixels.

The decompression module 220 may be operable to receive, with the compressed bit stream, an indication of whether the intra-prediction for a current block of pixels is based on directional prediction or pattern matching. The indication may be in the form of a signal and/or image header comprising one or more bits that provide information related to the intra-prediction type selected when the current block of pixels was initially compressed. In one embodiment of the invention, the indication may be received on a block-by-block basis, that is, for each block of pixels there is an indication of the intra-prediction type. In another embodiment of the invention, the indication may be received for those blocks of pixels for which the intra-prediction is of a particular type. In such instances, when no indication is received for a block of pixels, the other intra-prediction type is to be used.

When the current block of pixels is to be processed utilizing directional prediction, the decompression module 220 may intra-predict the current block of pixels based on reconstructed pixels neighboring the current block of pixels. Once the current block of pixels is intra-predicted, the decompression module 220 may reconstruct the current block of pixels based on the results from the directional prediction.

When the current block of pixels is to be processed utilizing pattern matching, the decompression module 220 may intra-predict the current block of pixels based on the reconstructed block of pixels with the matching pattern. The decompression module 220 may determine which reconstructed block of pixels has the matching pattern based on a two-dimensional vector or other like parameter received with the compressed bit stream for the current block of pixels. Once the current block of pixels is intra-predicted, the decompression module 220 may reconstruct the current block of pixels based on the results from the pattern matching.

In operation, the decompression module 220 may decompress the image information in the compressed bit stream by reconstructing block of pixels of a video or still image utilizing the appropriate intra-prediction type for that block of pixels. In this regard, the decompression module 220 may detect information in the compressed bit stream that indicates whether the intra-prediction type for a particular block of pixels is based on directional prediction or pattern matching. When directional prediction is utilized as the basis for intra-predicting the current block of pixels, the decompression module 220 may intra-predict the current block of pixels based on a prediction mode received in the compressed bit steam for the current block of pixels. Once the intra-prediction is completed, the decompression module 200 may reconstruct the current block of pixels utilizing the intra-prediction results.

When pattern matching is utilized as the basis for intra-predicting the current block of pixels, the decompression module 220 may intra-predict the current block of pixels based on a vector or other positional relationship received in the compressed bit steam for the current block of pixels. Once the intra-prediction is completed, the decompression module 200 may reconstruct the current block of pixels utilizing the intra-prediction results.

The reconstructed blocks of pixels may be stored in the memory module 230 and may be retrieved by the decompression module 220 to decompress subsequent blocks of pixels. Moreover, the reconstructed blocks of pixels may be retrieved from the memory module 230 by the post-processing module 240 to be processed for display by the display module 250 and/or to be communicated to a device external to the device 200.

FIG. 3A is a diagram that illustrates intra-prediction of a current block of pixels based on prediction direction, in accordance with an embodiment of the invention. Referring to FIG. 3A, there is shown a portion of a video or still image that is being processed by a conventional intra-prediction operation such as directional prediction, for example. In this instance, a device that performs intra-prediction operations such as the compression module 120 and the decompression module 220 described above with respect to FIGS. 1 and 2 may be utilized to perform directional prediction. The portion of the video or still image shown in FIG. 3A may comprise reconstructed blocks of pixels 310, 312, 314, 316, and 318 (shown in white). The portion of the video or still image also comprises a current block of pixels 320 (shown in a dotted pattern) and a next block of pixels 322 (shown in a diagonal-lines pattern). In addition, neighboring pixels 319 are indicated to the left and above of the current block 320.

In conventional intra-prediction or directional prediction, the current block 320 may be intra-predicted by calculating a prediction error for each of a plurality of prediction modes based on the values of at least a portion of the neighboring pixels 319. The prediction error for each of the various prediction modes may be based on a sum of absolute differences (SAD) calculation. Selecting a particular prediction mode to be utilized for directional prediction of the current block 320 may be based on the prediction error for that prediction mode, the uncompressed pixels of the current block, and/or the costs associated with coding the prediction mode selection.

Each prediction mode is typically associated with a particular direction. For example, when the pixels in the current block 320 comprise luminance information and the block size is 4×4, there may be nine (9) different directions or prediction modes from which one is to be selected. Those directions or prediction modes may comprise a vertical mode, a horizontal mode, a DC mode, a diagonal down-left mode, a diagonal down-right mode, a vertical-right mode, a horizontal-down mode, a vertical-left mode, and a horizontal-up mode. The DC mode may refer to a mean of several of the neighboring pixels 319.

In another example, when the pixels in the current block 320 comprise luminance information and the block size is 16×16, there may be four (4) different directions or prediction modes from which one is to be selected. Those directions or prediction modes may comprise a vertical mode, a horizontal mode, a DC mode, and a plane mode.

In yet another example, when the pixels in the current block 320 comprise chrominance information and the block size is 8×8, there may be four (4) different directions or prediction modes from which one is to be selected. Those directions or prediction modes may comprise a DC mode, a horizontal mode, a vertical mode, and a plane mode.

The compression module 120, for example, may intra-predict the current block 320 based on a particular prediction mode once one of the prediction modes is selected as a result of the criteria described above. The results from the intra-prediction may be subtracted from the uncompressed pixels of the current block 320, and the difference may be transformed, quantized, and/or encoded when generating the compressed bit stream. Similarly, the decompression module 220, for example, may intra-predict the current block 320 based on a known prediction mode received as part of the compressed bit stream comprising the information related to the current block 320. The prediction mode may be known from being embedded into the compressed bit stream. The current block 320 may be reconstructed by having results from the intra-prediction added to the difference information for the current block 320 received in the compressed bit stream after such difference information has been decoded, inverse quantized, and inverse transformed.

FIG. 3B is a diagram that illustrates intra-prediction of a current block of pixels based on pattern matching, in accordance with an embodiment of the invention. Referring to FIG. 3B, there is shown the portion of the video or still image described above with respect to FIG. 3A. In this instance, the intra-prediction of the current block 320 is based on a pattern match between the current block 320 and one of a plurality of candidate blocks. In the example shown in FIG. 3B, in addition to the reconstructed blocks 310, 312, 314, 316, and 318 that result from the tile-based manner in which the video or still image is handled, other candidates may be considered such as blocks 330, 340, and 350, for example. Block 330 (shown with dashed lines) may be based on reconstructed pixels from blocks 310 and 318. Block 340 (shown with dotted-dashed lines) may be based on reconstructed pixels from blocks 312 and 314. Block 350 (shown with dotted lines) may be based on reconstructed pixels from blocks 316 and 318. In this instance, some of the reconstructed pixels in block 330 are also common to block 350. Many different candidate blocks may be considered for pattern matching. The candidate blocks shown in FIG. 3B are provided for purposes of illustration and not of limitation.

In some embodiments of the invention, the candidate blocks may be constructed from interpolated pixels that are calculated from the reconstructed pixels in blocks 310-318. For example, a candidate block may comprise interpolated pixels that are offset from a row and/or column of reconstructed pixels by a fraction of an integer pixel unit. Moreover, the region from which reconstructed pixels may be considered to determine candidate blocks for pattern matching may be limited based on buffer capacity of the device. In some embodiments of the invention, the region may be limited to the row of reconstructed blocks above the current block 320 (e.g., blocks 310, 312, and 314) and up to two blocks to the left of current block 320 (e.g., blocks 316, 318). In other embodiments of the invention, when a larger buffer is available, the region may extend beyond the row above the current block 320 and beyond two blocks to the left of the current block 320.

A device, such as the compression module 120, for example, may intra-predict the current block 320 by searching from among the various possible candidate blocks to select one that best matches a pattern in the current block 320. In the example illustrated by FIG. 3B, block 350, which comprises reconstructed pixels from blocks 316 and 318, proves to be the best candidate, that is, the candidate with the best pattern match to the current block 320. The best candidate may also be referred to as the matching prediction block. Accordingly, a vector d, which provides information relating to a positional relationship between the current block 320 and the candidate block 350, may be encoded and embedded into the compressed bit stream generated by the compression module 120. The vector d may be a two-dimensional vector that indicates a relative or absolute positional relationship between the current block 320 and the best match, which in this example is block 350. The vector d may provide the positional relationship between a pixel 322 in the current block 320 and a pixel 352 (shown with dotted lines) in block 350. Pixels 322 and 352 may be collocated, that is, may be in the same location within their respective blocks. In some instances, the vector d may comprise positional relationship information that is based on a fraction of an integer pixel unit.

The selection of the best matching candidate or matching prediction block may be based on the difference or error between the current block 320 and the candidate blocks, and/or on the costs associated with coding the vector d or other like information. Such difference or error may be calculated based on a sum of absolute differences or other like technique.

The results from the intra-prediction may be subtracted from the uncompressed pixels of the current block 320, and the difference may be transformed, quantized, and/or encoded by the compression module 120 when generating the compressed bit stream.

In some embodiments of the invention, the group of candidate blocks may be limited to simplify intra-prediction based on pattern matching. For example, the group of candidate blocks may be limited to those that may be formed from reconstructed pixels to the left of the current block 320. In such instances, the vector d may be a one-dimensional vector since it may need only to indicate the position of candidate blocks left of the current block 320. In another example, the group of candidate blocks may be limited to those that may be formed from reconstructed blocks of pixels in the row of reconstructed blocks above the current block 320. Other limitations regarding which candidate blocks may be formed and available for pattern matching may be apparent from the various examples provided above.

A device, such as the decompression module 220, may intra-predict the current block 320 based on the reconstructed pixels in block 350 since such block represents the matching prediction block for the current block 320. Block 350 may be known to be the best match for the current block 320 from the information in vector d, which is received as part of the compressed bit stream comprising the information related to the current block 320. The current block 320 may be reconstructed by having results from the pattern matching intra-prediction added to the difference information for the current block 320 that is received in the compressed bit stream after such difference information has been decoded, inverse quantized, and inverse transformed.

FIG. 3C is a diagram that illustrates intra-prediction of a current block of pixels based on sub-block pattern matching, in accordance with an embodiment of the invention. Referring to FIG. 3C, there is shown the portion of the video or still image described above with respect to FIG. 3A. In this instance, the intra-prediction of the current block 320 is based on a pattern match between sub-blocks of the current block 320 and sub-blocks based on reconstructed pixels from blocks 310, 312, 314, 316, and 318.

In the example shown in FIG. 3C, the current block 320 may comprise or be formed from sub-blocks 323, 324, 325, and 326. Also shown in FIG. 3C are pattern matching sub-blocks 360, 370, 380, and 390, all of which are shown with dotted lines. Sub-block 360 may be based on reconstructed pixels from block 310. Sub-block 370 may be based on reconstructed pixels from blocks 312 and 314. Sub-block 380 may be based on reconstructed pixels from blocks 316 and 318. Sub-block 390 may be based on reconstructed pixels from blocks 316 and 318. Pattern matching sub-blocks 360, 370, 380, and 390 may have been selected from a plurality of candidate sub-blocks that may be formed from reconstructed pixels in blocks 310-318. The matching pattern sub-blocks shown in FIG. 3C are provided for purposes of illustration and not of limitation.

In some embodiments of the invention, the candidate sub-blocks may be constructed from interpolated pixels that are calculated from the reconstructed pixels in blocks 310-318. For example, a candidate sub-block may comprise interpolated pixels that are offset from a row and/or column of reconstructed pixels by a fraction of an integer pixel unit. Moreover, the region from which reconstructed pixels may be considered to determine candidate sub-blocks for pattern matching may be limited based on buffer capacity of the device. In some embodiments of the invention, the region may be limited to the row of reconstructed blocks above the current block 320 (e.g., blocks 310, 312, and 314) and up to two blocks to the left of current block 320 (e.g., blocks 316, 318). In other embodiments of the invention, when a larger buffer is available, the region may extend beyond the row above the current block 320 and beyond two blocks to the left of the current block 320.

A device, such as the compression module 120, for example, may intra-predict the current block 320 by searching from among the various possible candidate sub-blocks to select the ones that best match patterns in the sub-blocks of the current block 320. In the example illustrated by FIG. 3C, sub-blocks 360, 370, 380, and 390 are the best match or matching prediction sub-blocks for sub-blocks 323, 324, 325, and 326 of the current block 320, respectively.

In this example, four (4) vectors, vectors d1, d2, d3, and d4, may provide information relating to the positional relationship between the matching prediction sub-blocks and the sub-blocks of the current block 320. The vectors d1, d2, d3, and d4 may be encoded and embedded into the compressed bit stream generated by the compression module 120. The vectors may be two-dimensional vectors that indicate a relative or absolute positional relationship between sub-blocks. For example, vector d1 may provide a positional relationship between a pixel 323a in sub-block 323 and a collocated pixel 362 in sub-block 360. Vector d2 may provide a positional relationship between a pixel 324a in sub-block 324 and a collocated pixel 372 in sub-block 370. Vector d3 may provide a positional relationship between a pixel 325a in sub-block 325 and a collocated pixel 382 in sub-block 380. Similarly, vector d4 may provide a positional relationship between a pixel 326a in sub-block 326 and a collocated pixel 392 in sub-block 390. The location of the pixels 323a, 324a, 325a, and 326a within their respective sub-blocks may be the same for all, the same for some, or different for all. In some instances, one or more of the vectors d1, d2, d3, and d4 may comprise positional relationship information that is based on a fraction of an integer pixel unit.

The selection of the matching prediction sub-blocks may be based on the difference or error between a sub-block of the current block 320 and the candidate sub-blocks, on the costs associated with coding the vector that corresponds to a candidate sub-block, and/or on other like information. Such difference or error may be calculated based on a sum of absolute differences or other like technique.

The results from the intra-prediction may be subtracted from the uncompressed pixels of the current block 320, and the difference may be transformed, quantized, and/or encoded by the compression module 120 when generating the compressed bit stream.

In some embodiments of the invention, the group of candidate sub-blocks may be limited to simplify intra-prediction based on pattern matching. For example, the group of candidate sub-blocks may be limited to those that may be formed from reconstructed pixels to the left of the current block 320. In another example, the group of candidate sub-blocks may be limited to those that may be formed from reconstructed blocks of pixels in the row of reconstructed blocks above the current block 320. Other limitations regarding which candidate sub-blocks may be formed and available for pattern matching may be apparent from the various examples provided above.

A device, such as the decompression module 220, may intra-predict the current block 320 based on the reconstructed pixels in sub-blocks 360, 370, 380, and 390 since such sub-blocks represent the matching prediction sub-blocks for the current block 320. Sub-blocks 360, 370, 380, and 390 may be known to be the best match for the sub-blocks of the current block 320 from the information in vectors d1, d2, d3, and d4, which is received as part of the compressed bit stream comprising the information related to the current block 320. The current block 320 may be reconstructed by having results from the pattern matching intra-prediction added to the difference information for the current block 320 that is received in the compressed bit stream after such difference information has been decoded, inverse quantized, and inverse transformed.

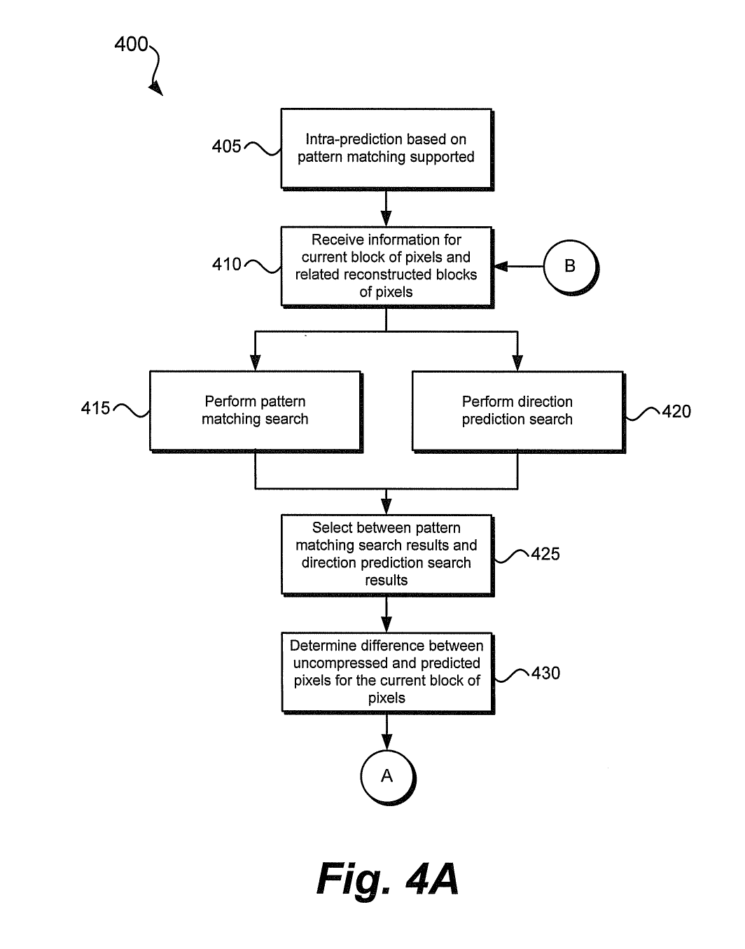

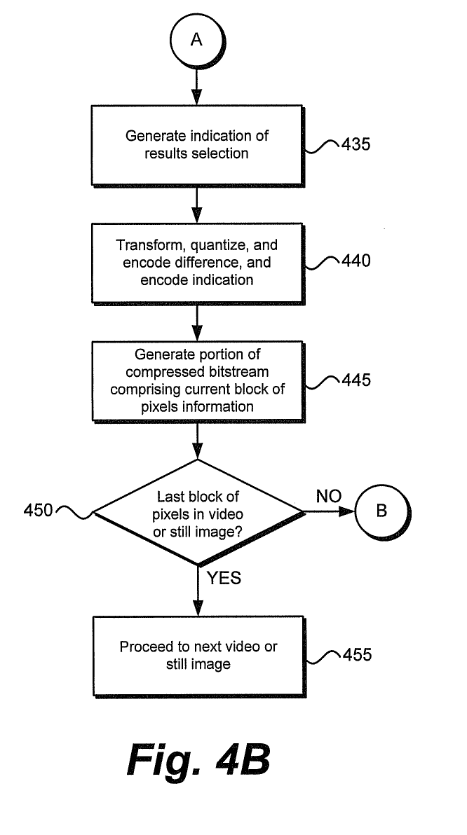

FIGS. 4A and 4B illustrate a flow chart with exemplary steps for the generation of a compressed bit stream when intra-prediction based on pattern match is enabled in a device, in accordance with an embodiment of the invention. Referring to FIGS. 4A and 4B, there is shown a flow chart 400 in which, at step 405, intra-prediction that is based on pattern matching is supported by a device. In some instances, the compression module 120 may be enabled to perform both directional prediction and pattern matching in the blocks of pixels of a video or still image in order to select the results of one scheme or the other based on cost metrics associated with each intra-prediction type.

At step 410, information regarding the current block of pixels and related reconstructed blocks of pixels may be received. For example, such information may be stored in the memory module 130 and/or in a local memory (no shown) within the compression module 120. The related reconstructed blocks of pixels may refer to those reconstructed blocks of pixels that are available as candidates for pattern matching. As described above, the available candidates for pattern matching may be a limited or reduced group to simplify the pattern matching operations. The pixels may be reconstructed based on inverse quantization and inverse transform operations.

At step 415, a pattern match search may be performed as described above with respect to FIGS. 3B and 3C. For example, a particular reconstructed block of pixels may be selected as the best pattern match for the current block of pixels. In another example, more than one sub-block of the reconstructed blocks of pixels may be selected as best pattern matches to the sub-blocks of the current block of pixels. The selection is based on a cost metric that is determined for each of the candidates. At step 420, a directional prediction search may be performed as described above with respect to FIG. 3A. For example, a particular prediction mode may provide the best cost metric from among the various possible prediction modes for the current block of pixels.

At step 425, based on the search results from steps 415 and 420, a selection is made between directional prediction and prediction matching to intra-predict the current block of pixels. Since the cost metrics utilized by the compression module 120 to carry out both searches are substantially similar, the selection may be based on a comparison of the cost metric associated with the best match produced by the pattern match search with the cost metric associated with the best prediction mode produced by the prediction direction search. At step 430, based on the selection made at step 425, the current block of pixels may be intra-predicted and a difference between the predicted pixels and the uncompressed pixels of the current block may be determined.

At step 435, an indication is generated that provides inforamtion related to the intra-prediction type selected at step 425. For example, the compression module 120 may generate a signal or an image header that comprises one or more bits to indicate whether the intra-prediction type selected at step 425 is based on directional prediction or patter matching. Such indication may be provided for each block of pixels in a video or still image or may be provided when a block of pixels is intra-predicted utilizing one of the two intra-prediction types. For example, the indication may only be generated when pattern matching is selected with the assumption that for all other instances directional prediction is selected.

At step 440, the difference determined at step 430 may be transformed, quantized, and encoded by, for example, the compression module 120. Moreover, the indication generated at step 435 may be encoded by, for example, the compression module 120. At step 445, the portion of a compressed bit stream that comprises information related to the current block of pixels may be generated based on the compressed information produced at step 440. In this regard, the encoded indication may be embedded into the compressed bit stream separately from the compressed pixel inforamtion for the current block.

At step 450, when the last of the blocks of pixels for a video or still image has been compressed and included into the compressed bit stream, the process may proceed to step 455 where a next video or still image may be processed. Otherwise, the process may return to step 410 where a next or subsequent current block of pixels is to be processed.

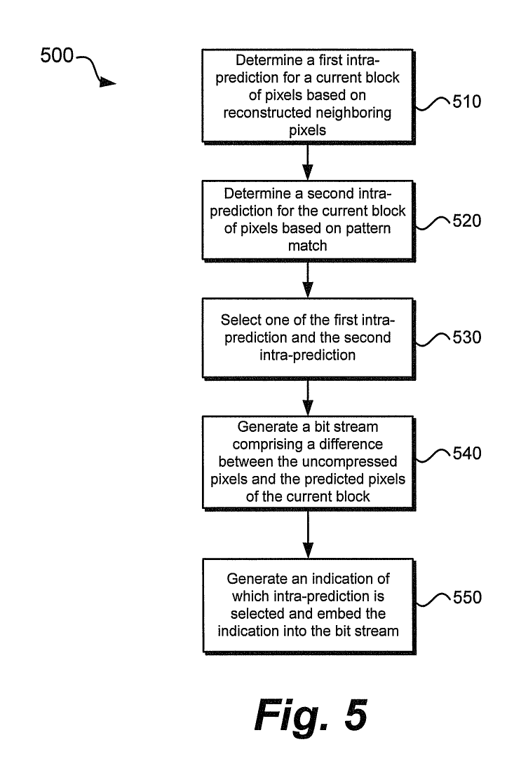

FIG. 5 is a flow chart that illustrates exemplary steps in a block-by-block intra-prediction selection to generate a compressed bit stream, in accordance with an embodiment of the invention. Referring to FIG. 5, there is shown a flow chart 500 in which, at step 510, the compression module 120 in FIG. 1 may determine a first intra-prediction for a current block of pixels based on reconstructed neighboring pixels. Such first intra-prediction may be substantially similar to the directional prediction described above. At step 520, the compression module 120 may determine a second intra-prediction for the current block of pixels based on a pattern match between the current block of pixels and one of a plurality of reconstructed blocks of pixels. Such second intra-prediction may be substantially similar to the pattern matching described above. Moreover, in some instances, the second intra-prediction for the current block of pixels may be based on a pattern match between sub-blocks or sub-partitions of the current block of pixels and sub-blocks or sub-partitions associated with one or more reconstructed blocks of pixels.

At step 530, the compression module 120 may select between the first intra-prediction and the second intra-prediction to intra-predict the current block of pixels. The selection may be based on cost metrics that may be available from the operations associated with the first intra-prediction at step 510 and the operations associated with the second intra-prediction at step 520.

At step 540, the compression module 120 may generate a compressed bit stream that comprises a difference between the uncompressed pixels of the current block of pixels and the intra-predicted pixels of the current block of pixels generated from the selected intra-prediction.

At step 550, the compression module 120 may generate an indication of which intra-prediction was selected at step 530 and may embed the indication into the compressed bit stream. In this manner, a device receiving the compressed bit stream for decompression may know whether to intra-predict the current block of pixels utilizing the first intra-prediction or the second intra-prediction.

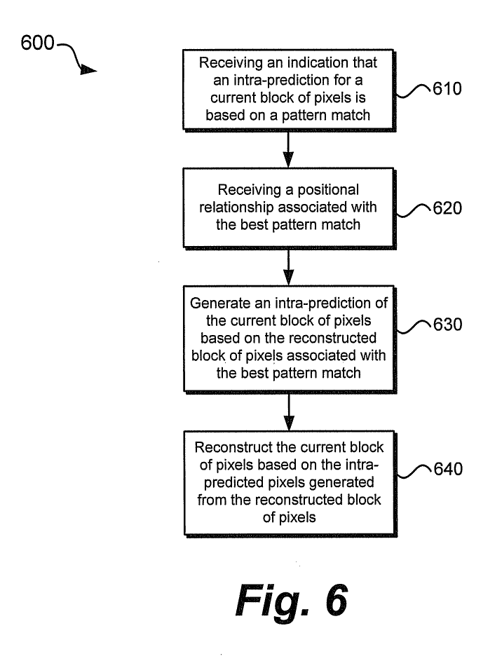

FIG. 6 is a flow chart that illustrates exemplary steps in the reconstruction of a current block of pixels based on information received in a compressed bit stream for the current block of pixels, in accordance with an embodiment of the invention. Referring to FIG. 6, there is shown a flow chart 600 in which, at step 610, the decompression module 220 in FIG. 2 may receive from a compressed bit stream an indication that an intra-prediction for a current block of pixels being processed is based on pattern matching. At step 620, the decompression module 220 may also receive from the compressed bit stream a positional relationship associated with the reconstructed block of pixels that provided the best match. For example, the decompression module 220 may receive a vector that indicates a relative or absolute position of the best match to the position of the current block of pixels. When the pattern matching is based on sub-blocks or sub-partitions, the decompression module 220 may receive a plurality of vectors that indicate a relative or absolute position of the best matching sub-blocks to the corresponding sub-blocks in the current block of pixels.

At step 630, the decompression module 220 may generate an intra-prediction of the current block of pixels based on the pixel and vector information received from the compressed bit stream. At step 640, the decompression module 220 may reconstruct the current block of pixels by adding the intra-predicted pixels to a difference information for the current block of pixels received in the compressed bit stream after such difference information has been decoded, inverse quantized, and inverse transformed.

Another embodiment of the invention may provide a non-transitory machine and/or computer readable storage and/or medium, having stored thereon, a machine code and/or a computer program having at least one code section executable by a machine and/or a computer, thereby causing the machine and/or computer to perform the steps as described herein for video and image coding using pattern matching for intra-prediction.

Accordingly, the present invention may be realized in hardware, software, or a combination of hardware and software. The present invention may be realized in a centralized fashion in at least one computer system or in a distributed fashion where different elements may be spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method, comprising:
in a device that is operable to process one or both of video images and still images:
determining a first intra-prediction of a current block of pixels based on reconstructed pixels neighboring the current block of pixels;
determining a second intra-prediction of the current block of pixels based on a match between a pattern in a reconstructed block of pixels and a pattern in the current block of pixels;
selecting one of the first intra-prediction of the current block of pixels and the second intra-prediction of the current block of pixels based on results from the determination of the first intra-prediction of the current block of pixels and the determination of the second intra-prediction of the current block of pixels; and
generating a bit stream comprising a difference between uncompressed pixels of the current block of pixels and intra-predicted pixels of the current block of pixels predicted utilizing the selected intra-prediction.

2. The method of claim 1, comprising:
generating an indication that the second intra-prediction of the current block of pixels is selected; and
embedding the generated indication for the current block of pixels into the generated bit stream.

3. The method of claim 1, wherein a size of the current block of pixels is one of 16×16, 8×16, 16×8, 8×8, 8×4, 4×8, and 4×4.

4. The method of claim 1, wherein when the second intra-prediction of the current block of pixels is selected, the method comprises:
encoding a positional relationship between the current block of pixels and the reconstructed block of pixels.

5. The method of claim 1, wherein the selecting comprises determining a cost metric for each of the determination of the first intra-prediction of the current block of pixels and the determination of the second intra-prediction of the current block of pixels.

6. The method of claim 1, comprising:
determining the second intra-prediction of the current block of pixels based on a match between a pattern in a sub-block of the reconstructed block of pixels and a pattern in a sub-block of the current block of pixels; and
encoding a positional relationship between the sub-block of the reconstructed block of pixels and the sub-block of the current block of pixels.

7. The method of claim 1, comprising:
determining a first intra-prediction of a next block of pixels based on reconstructed pixels neighboring the next block of pixels;
determining a second intra-prediction of the next block of pixels based on a match between a pattern in a reconstructed block of pixels and a pattern in the next block of pixels;
selecting one of the first intra-prediction of the next block of pixels and the second intra-prediction of the next block of pixels based on results from the determination of the first intra-prediction of the next bock of pixels and the determination of the second intra-prediction of the next block of pixels, wherein the generated bit stream comprises a difference between uncompressed pixels of the next block of pixels and intra-predicted pixels of the next block of pixels predicted utilizing the selected intra-prediction;
generating an indication of which intra-prediction of the next block of pixels is selected; and
embedding the generated indication for the next block of pixels into the generated bit stream.

8. A method, comprising:
in a device that is operable to process one or both of video images and still images:
receiving an indication that an intra-prediction of a current block of pixels is based on a match between a pattern in the current block of pixels and a pattern in a reconstructed block of pixels;
receiving a positional relationship between the current block of pixels and the reconstructed block of pixels;
generating the intra-prediction of the current block of pixels based on the received positional relationship; and
reconstructing the current block of pixels based on the generated intra-prediction of the current block of pixels.

9. The method of claim 8, wherein a size of the current block of pixels is one of 16×16, 8×16, 16×8, 8×8, 8×4, 4×8, and 4×4.

10. The method of claim 8, wherein a pattern in a sub-block of the current block matches a pattern in a sub-block of the reconstructed block of pixels, the method comprising:
receiving a positional relationship between the sub-block of the current block of pixels and the sub-block of the reconstructed block of pixels.; and
generating the intra-prediction of the current block of pixels based on the received sub-block positional relationship.

11. A system, comprising:
one or more processors and/or circuits that are operable to:
determine a first intra-prediction of a current block of pixels based on reconstructed pixels neighboring the current block of pixels;
determine a second intra-prediction of the current block of pixels based on a match between a pattern in a reconstructed block of pixels and a pattern in the current block of pixels;
select one of the first intra-prediction of the current block of pixels and the second intra-prediction of the current block of pixels based on results from the determination of the first intra-prediction of the current block of pixels and the determination of the second intra-prediction of the current block of pixels; and
generate a bit stream comprising a difference between uncompressed pixels of the current block of pixels and intra-predicted pixels of the current block of pixels predicted utilizing the selected intra-prediction.

12. The system of claim 11, wherein the one or more processors and/or circuits are operable to:
generate an indication that the second intra-prediction of the current block of pixels is selected; and
embed the generated indication for the current block of pixels into the generated bit stream.

13. The system of claim 11, wherein the current block of pixels is one of a 16×16 block of pixels, an 8×8 block of pixels, and a 4×4 block of pixels.

14. The system of claim 11, wherein when the second intra-prediction of the current block of pixels is selected, the one or more processors and/or circuits are operable to:
encode a positional relationship between the current block of pixels and the reconstructed block of pixels.

15. The system of claim 11, wherein the one or more processors and/or circuits are operable to:
determine a cost metric for each of the determination of the first intra-prediction of the current block of pixels and the determination of the second intra-prediction of the current block of pixels; and
select one of the first intra-prediction of the current block of pixels and the second intra-prediction of the current block of pixels based on the cost metrics.

16. The system of claim 11, wherein the one or more processors and/or circuits are operable to:
determine the second intra-prediction of the current block of pixels based on a match between a pattern in a sub-block of a reconstructed block of pixels and a pattern in a sub-block of the current block of pixels; and
encode a positional relationship between the sub-block of the reconstructed block of pixels and the sub-block of the current block of pixels.

17. The system of claim 11, wherein the one or more processors and/or circuits are operable to:
determine a first intra-prediction of a next block of pixels based on reconstructed pixels neighboring the next block of pixels;
determine a second intra-prediction of the next block of pixels based on a match between a pattern in a reconstructed block of pixels and a pattern in the next block of pixels;
select one of the first intra-prediction of the next block of pixels and the second intra-prediction of the next block of pixels based on results from the determination of the first intra-prediction of the next block of pixels and the determination of the second intra-prediction of the next block of pixels, wherein the generated bit stream comprises a difference between uncompressed pixels of the next block of pixels and intra-predicted pixels of the next block of pixels predicted utilizing the selected intra-predictions;
generate an indication of which intra-prediction of the next block of pixels is selected; and
embed the generated indication for the next block of pixels into the generated bit stream.

18. A system, comprising:
one or more processors and/or circuits that are operable to:
receive an indication that an intra-prediction of a current block of pixels is based on a match of a pattern in the current block of pixels and a pattern in a reconstructed block of pixels;
receive a positional relationship between the current block of pixels and the reconstructed block of pixels;
generate the intra-prediction of the current block of pixels based on the positional relationship; and
reconstruct the current block of pixels based on the generated intra-prediction of the current block of pixels.

19. The system of claim 18, wherein the current block of pixels is one of a 16×16 block of pixels, an 8×8 block of pixels, and a 4×4 block of pixels.

20. The system of claim 18, wherein:
a pattern in a sub-block of the current block matches a pattern in a sub-block of the reconstructed block of pixels; and
the one or more processors and/or circuits that are operable to:
receive a positional relationship between the sub-block of the current block of pixels and the sub-block of the reconstructed block of pixels.; and
generate the intra-prediction of the current block of pixels based on the received sub-block positional relationship.
